(19) United States
(12) Patent Application Publication
(10) Pub. No.: US 2026/0202525 A1
(43) Pub. Date: Jul. 16, 2026

(54) METHOD AND APPARATUS FOR DETERMINING OUTPUT VOLTAGE, ELECTRONIC DEVICE, AND STORAGE MEDIUM

(71) Applicant: Hangzhou Longshuo Technology Co., Ltd., Hangzhou (CN)

(72) Inventors: Jianfei FENG, Hangzhou (CN); Leilei XU, Hangzhou (CN)

(21) Appl. No.: 19/537,364

(22) Filed: Feb. 11, 2026

Related U.S. Application Data
(63) Continuation of application No. PCT/CN2025/080634, filed on Mar. 5, 2025.

(30) Foreign Application Priority Data
Jan. 14, 2025 (CN) 202510052509.9

(51) Int. Cl. G01S 7/497; G01S 7/4865; G01S 17/10; G01S 17/42

(52) U.S. Cl. CPC G01S 7/497; G01S 7/4865; G01S 17/10; G01S 17/42

(57) ABSTRACT

This application provides a method and apparatus for determining an output voltage, an electronic device, and a storage medium, relating to the field of laser technology. The method includes: emitting a plurality of transmitted laser pulse signals toward a target object, where each transmitted laser pulse signal in the plurality of transmitted laser pulse signals is generated based on a different output voltage; receiving a plurality of reflected laser pulse signals reflected back from the target object; processing the plurality of reflected laser pulse signals to obtain a target pulse signal; determining, based on the target pulse signal, a target distance value corresponding to a target pulse peak value; and determining, based on a predetermined correspondence, a target output voltage corresponding to the target distance value. The technical solutions provided in this application achieve the effect of improving the efficiency of determining the output voltage.

### CROSS-REFERENCE TO RELATED APPLICATIONS

The present application is a continuation of International Application No. PCT/CN2025/080634, filed on March 05, 2025, which claims priority to Chinese patent application No. 202510052509.9, titled "METHOD AND APPARATUS FOR DETERMINING OUTPUT VOLTAGE, ELECTRONIC DEVICE, AND STORAGE MEDIUM", filed on January 14, 2025, the entire contents of which are incorporated herein by reference.

### TECHNICAL FIELD

This application relates to the field of laser technology, and specifically to a method and apparatus for determining an output voltage, an electronic device, and a storage medium.

### BACKGROUND

Currently, laser technology has been widely applied in industrial production and scientific research, such as laser processing or laser ranging. As the requirements for laser processing quality and efficiency continue to increase, how to precisely control the output of a laser device has become one of the urgent problems to be solved. The working principle of a laser device determines that its output is directly affected by the power supply. Therefore, finely adjusting the power supply of the laser device is a key factor in ensuring the quality of laser processing. In laser ranging, during close-range measurement, the laser energy is likely to be excessively strong. Therefore, it is necessary to adjust the output voltage. Currently, most methods on the market rely on feedback adjustment, which essentially involves trial-and-error testing with a plurality of output voltages. For example, a target voltage or power value is first set, then the laser device starts working and emits a laser. Afterward, the system detects the actual output power of the laser device or the intensity of the received reflected laser signal and compares it with the target value. If there is a deviation between the actual value and the target value, the system adjusts the output voltage of the power supply to attempt to reduce this deviation. It can be seen that the methods in the related art require a plurality of laser emissions and waiting for determination of the target voltage, resulting in excessively high time consumption and low efficiency in determining the output voltage.

### SUMMARY

In order to solve the above technical problems, this application provides a method and apparatus for determining an output voltage, an electronic device, and a storage medium.

According to a first aspect, this application provides the method for determining an output voltage, applied to a laser device, and including: emitting a plurality of transmitted laser pulse signals toward a target object, where each transmitted laser pulse signal in the plurality of transmitted laser pulse signals is generated based on a different output voltage; receiving a plurality of reflected laser pulse signals reflected back from the target object, where each reflected laser pulse signal in the plurality of reflected laser pulse signals corresponds to one transmitted laser pulse signal in the plurality of transmitted laser pulse signals; processing the plurality of reflected laser pulse signals to obtain a target pulse signal; determining, based on the target pulse signal, a target distance value corresponding to a target pulse peak value; and determining, based on a predetermined correspondence, a target output voltage corresponding to the target distance value.

With the adoption of the above technical solution, a plurality of transmitted laser pulse signals generated based on different output voltages are emitted toward the target object, and the reflected laser pulse signals reflected back from the target object are received. Then, the reflected laser pulse signals are processed to obtain the target pulse signal, and the target distance value is further determined based on the peak value of the target pulse signal. Finally, the target output voltage corresponding to the target distance value is determined using the predetermined correspondence. In this way, the output voltage of the laser device can be determined. This avoids the cumbersome process in the related art that requires a plurality of attempts and adjustments of the output voltage. Instead, a plurality of laser pulses under different voltages are emitted at one time, and the optimal output voltage is directly determined through analysis of the reflected signals. This method not only improves efficiency but also reduces errors and uncertainties that may be caused by a plurality of attempts and adjustments.

Optionally, the processing the plurality of reflected laser pulse signals to obtain a target pulse signal includes: superimposing the plurality of reflected laser pulse signals to obtain the target pulse signal.

With the adoption of the above technical solution, the plurality of reflected laser pulse signals are superimposed to obtain the target pulse signal. This superimposition processing can enhance the intensity of the target pulse signal while suppressing the influence of noise and interference signals to a certain extent. Specifically, since the target pulse signal is reflected from the same target, it has similar waveforms and features in the plurality of pulse signals. These similar signal components can be enhanced through superimposition processing. In contrast, noise and interference signals are random and uncorrelated, so their intensity is offset or weakened to a certain extent during the superimposition process. In other words, the intensity of the target pulse signal is enhanced, and noise and interference are suppressed.

Optionally, the determining, based on the target pulse signal, a target distance value corresponding to a target pulse peak value includes: determining the target pulse peak value from the target pulse signal, where the target pulse peak value is used to represent a maximum signal amplitude value in the target pulse signal; determining a target flight time corresponding to the target pulse peak value; and obtaining the target distance value based on the target flight time.

With the adoption of the above technical solution, the largest signal amplitude value, namely the target pulse peak value, is identified from the target pulse signal. This step ensures that the strongest and most reliable portion of the reflected laser pulse signals is selected. Next, the flight time corresponding to the target pulse peak value is determined, that is, the time experienced by the pulse from emission to reflection by the target object and reception. Once the target flight time is determined, the target distance value can be accurately calculated. In other words, through identification of the target pulse peak value to calculate the distance, the influence of noise and interference can be reduced to the greatest extent, thereby improving the accuracy of the measurement result. This technical solution helps to quickly and accurately determine the target pulse peak value from the target pulse signal, and further obtain the corresponding target flight time, thereby calculating the target distance value and improving the speed and accuracy of output voltage determination.

Optionally, the determining, based on a predetermined correspondence, a target output voltage corresponding to the target distance value includes: establishing the predetermined correspondence, where the predetermined correspondence is used to represent a correspondence between a measurement distance and an output voltage; and determining, as the target output voltage, an output voltage corresponding to the target distance value in the predetermined correspondence.

With the adoption of the above technical solution, the target output voltage corresponding to the target distance value can be quickly determined by establishing the predetermined correspondence. This avoids the time consumption problem of a plurality of laser emissions and waiting in the conventional feedback adjustment method, reduces the number of laser emissions and waiting determinations, and significantly improves the efficiency of output voltage determination.

Optionally, the establishing the predetermined correspondence includes: acquiring a plurality of sets of historical measurement data, where each set of historical measurement data includes data of a different measurement distance and data of a corresponding output voltage; and constructing an objective function based on the plurality of sets of historical measurement data, where the objective function represents a function between the output voltage and the measurement distance.

With the adoption of the above technical solution, a plurality of sets of historical measurement data are acquired, and the objective function is constructed based on these data, making the relationship between the output voltage and the measurement distance clearer and more accurate. This enables quick and accurate establishment of the predetermined correspondence, thereby improving the accuracy and speed of output voltage determination.

Optionally, the determining, based on a predetermined correspondence, a target output voltage corresponding to the target distance value includes: determining a target distance interval to which the target distance value belongs, and determining, based on the predetermined correspondence, the target output voltage corresponding to the target distance interval, where the predetermined correspondence includes a plurality of sets of correspondences between measurement distance intervals and output voltages.

With the adoption of the above technical solution, the target distance interval to which the target distance value belongs is first determined, and then the target output voltage corresponding to the target distance interval is determined based on the predetermined correspondence. The entire measurement distance range is divided into a plurality of intervals and the corresponding output voltage value is pre-determined for each interval, greatly reducing the search time. When it is necessary to determine the target output voltage, it is only necessary to find the interval to which the target distance value belongs and then directly read the output voltage value of that interval, without traversing the entire predetermined correspondence table.

Optionally, the processing the plurality of reflected laser pulse signals to obtain a target pulse signal includes: generating a target histogram based on the plurality of reflected laser pulse signals, where the target histogram is used to represent photon counts corresponding to different flight times, and the target pulse signal is represented by using the target histogram; and the determining, based on the target pulse signal, a target distance value corresponding to a target pulse peak value includes: determining, based on the target histogram, a target flight time corresponding to a maximum photon count, and determining the target distance value based on the target flight time.

With the adoption of the above technical solution, the target histogram is generated from the plurality of reflected laser pulse signals, and the target histogram is used to represent photon counts corresponding to different flight times. This enables more precise determination of the target pulse peak value, thereby improving the accuracy of the target flight time and the target distance value, and ultimately making the determination of the target output voltage more precise.

According to a second aspect, this application further provides an apparatus for determining an output voltage, located in a laser device, and including: an emitting module, configured to emit a plurality of transmitted laser pulse signals toward a target object, where each transmitted laser pulse signal in the plurality of transmitted laser pulse signals is generated based on a different output voltage; a receiving module, configured to receive a plurality of reflected laser pulse signals reflected back from the target object, where each reflected laser pulse signal in the plurality of reflected laser pulse signals corresponds to one transmitted laser pulse signal in the plurality of transmitted laser pulse signals; a processing module, configured to process the plurality of reflected laser pulse signals to obtain a target pulse signal; a first determination module, configured to determine, based on the target pulse signal, a target distance value corresponding to a target pulse peak value; and a second determination module, configured to determine, based on a predetermined correspondence, a target output voltage corresponding to the target distance value.

According to a third aspect, this application further provides an electronic device, including a memory and a processor, where a computer program is stored on the memory, and the processor, when executing the program, implements any of the above method steps.

According to a fourth aspect, this application further provides a computer-readable storage medium, where the computer-readable storage medium stores instructions, and the instructions, when executed, implement any of the above method steps.

To sum up, one or more technical solutions provided in this application have at least the following technical effects or advantages:

1. A plurality of laser pulses under different voltages are emitted at one time and the optimal output voltage is directly determined through analysis of the reflected signals, avoiding the cumbersome process of a plurality of attempts and adjustments of the output voltage in the related art. This method improves efficiency and reduces errors and uncertainties that may be caused by a plurality of attempts and adjustments.

2. The target pulse peak value can be quickly and accurately determined from the target pulse signal, and the corresponding target flight time can be further obtained, thereby calculating the target distance value and improving the speed and accuracy of output voltage determination.

3. An objective function is constructed using a plurality of sets of historical measurement data, allowing for a clearer and more accurate relationship between the output voltage and the measurement distance. This enables quick and accurate establishment of the predetermined correspondence, thereby improving the accuracy and speed of output voltage determination.

### BRIEF DESCRIPTION OF THE DRAWINGS

FIG. 1 is a flowchart of a method for determining an output voltage according to an embodiment of this application;

FIG. 2 is a schematic diagram of a received signal corresponding to a lower limit voltage according to an embodiment of this application;

FIG. 3 is a schematic diagram of a received signal corresponding to a preset voltage according to an embodiment of this application;

FIG. 4 is a schematic diagram of a received signal corresponding to an upper limit voltage according to an embodiment of this application;

FIG. 5 is a schematic diagram of a received signal after superimposition according to an embodiment of this application;

FIG. 6 is a structural block diagram of an apparatus for determining an output voltage according to an embodiment of this application; and

FIG. 7 is a schematic structural diagram of an electronic device according to an embodiment of this application.

Description of reference numerals: 700-electronic device; 701-processor; 702-communication bus; 703-user interface; 704-network interface; and 705-memory.

### DETAILED DESCRIPTION OF THE EMBODIMENTS

To enable those skilled in the art to better understand the technical solutions in this specification, the technical solutions in the embodiments of this specification will be clearly and completely described below with reference to the accompanying drawings in the embodiments of this specification. It is apparent that the described embodiments are merely some rather than all of the embodiments of this specification.

In the description of the present application, "for example", "example", or the like is used to represent giving an example, an illustration, or a description. Any embodiment or design solution described herein as "exemplary" or "for example" in the embodiments of the present disclosure should not be construed as being more preferred or advantageous over other embodiments or design solutions. Exactly, use of "for example", "example", or the like is intended to present a related concept in a specific manner.

In the description of the embodiments of the present disclosure, unless otherwise specified, "a plurality of" means two or more. Moreover, terms such as "first" and "second" are used only for the purpose of description and cannot be understood as indicating or implying relative importance or implicitly indicating the number of technical features denoted. Thus, features defined with "first" and "second" may explicitly or implicitly include one or more of the features. The terms "comprise", "include", "contain", "have", and their variations all mean "including but not limited to", unless otherwise emphasized.

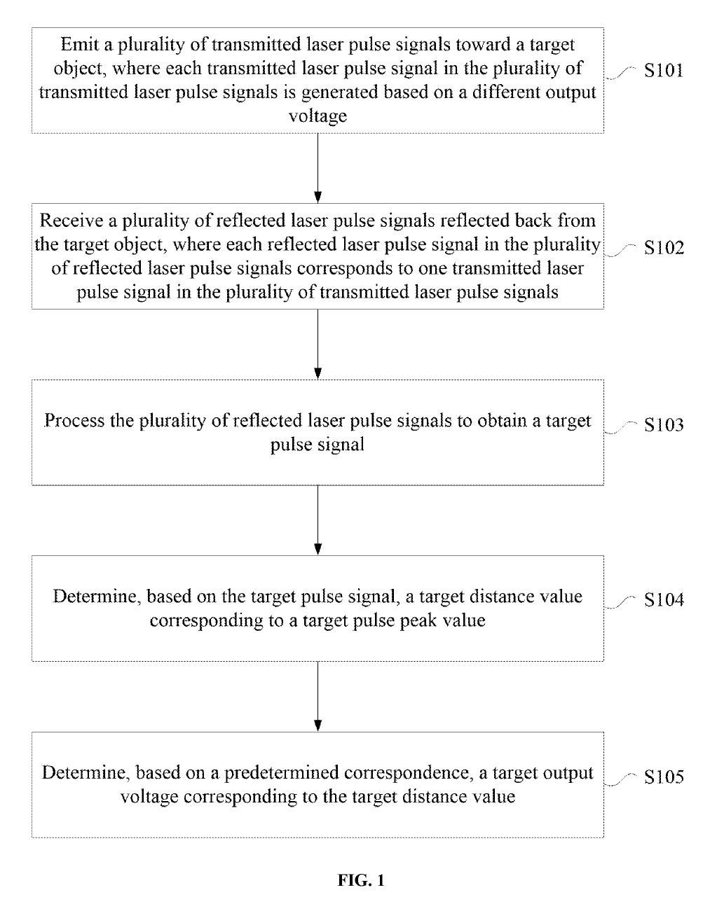

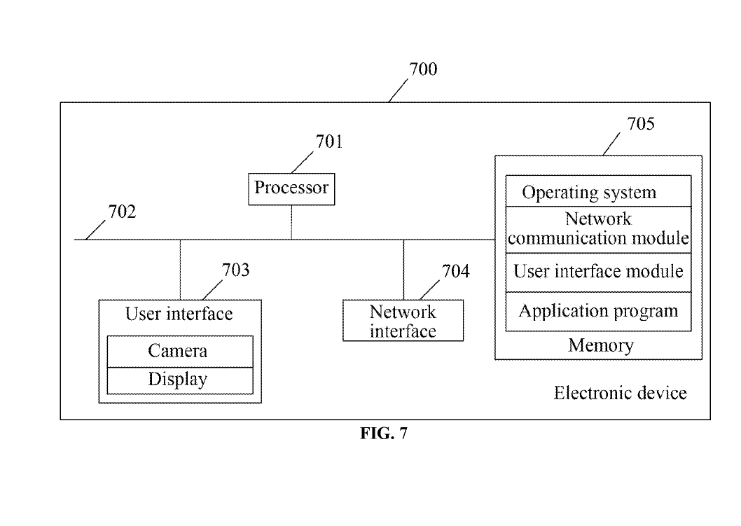

The embodiment of the present disclosure is described with reference to FIG. 1 and FIG. 7.

This application provides a method for determining an output voltage, applied to a laser device. Referring to FIG. 1, FIG. 1 is a flowchart of a method for determining an output voltage according to an embodiment of this application. The method includes the following steps:

Step S101. A plurality of transmitted laser pulse signals are emitted toward a target object, where each transmitted laser pulse signal in the plurality of transmitted laser pulse signals is generated based on a different output voltage.

Step S102. A plurality of reflected laser pulse signals reflected back from the target object are received, where each reflected laser pulse signal in the plurality of reflected laser pulse signals corresponds to one transmitted laser pulse signal in the plurality of transmitted laser pulse signals.

Step S103. The plurality of reflected laser pulse signals are processed to obtain a target pulse signal.

Step S104. A target distance value corresponding to a target pulse peak value is determined based on the target pulse signal.

Step S105. A target output voltage corresponding to the target distance value is determined based on a predetermined correspondence.

Through the above steps, a plurality of transmitted laser pulse signals generated based on different output voltages are emitted toward the target object, and the reflected laser pulse signals reflected back from the target object are received. Then, the reflected laser pulse signals are processed to obtain the target pulse signal, and the target distance value is further determined based on the peak value of the target pulse signal. Finally, the target output voltage corresponding to the target distance value is determined using the predetermined correspondence. In other words, these reflected laser pulse signals are processed, such that the target distance value corresponding to the target pulse peak value can be directly found, thereby quickly determining, based on the predetermined correspondence, the target output voltage matching the target distance value. In this way, the output voltage of the laser device can be determined, avoiding the cumbersome process in the related art that requires a plurality of attempts and adjustments of the output voltage. Instead, a plurality of laser pulses under different voltages are emitted at one time, and the optimal output voltage is directly determined through analysis of the reflected signals. This method not only improves efficiency but also reduces errors and uncertainties that may be caused by a plurality of attempts and adjustments.

In laser ranging and processing, due to the instability of laser energy, it is necessary to precisely control the output voltage of the laser device to ensure the accuracy of measurement and the quality of processing. Before the distance of an object is measured, the actual distance of the to-be-measured object (such as the above target object) is usually unknown, and therefore it is also unclear how much voltage should be output to the laser device. In the existing technology, different output voltages are tried a plurality of times for testing, and the accuracy of the output voltage is determined based on the results. For example, attempts are made with 10 V, 9 V, 8 V, and the like, or with 10 V, 5 V, 7.5 V, and the like. This requires a plurality of laser emissions and waiting for determination of the target voltage, resulting in long time consumption and low efficiency.

In practical applications, a plurality of groups of laser pulses are emitted under different voltages at one time and the reflected signals are quickly analyzed, such that the optimal output voltage can be quickly determined, thereby greatly improving efficiency. In practical applications, precise adjustment of the output voltage can ensure moderate energy of the laser during processing. This prevents affecting the processing quality due to excessively low energy and also avoids damaging the target object or causing safety hazards due to excessively high energy. This method is not only applicable to laser ranging but also can be widely applied in various industrial production and scientific research fields that require precise control of laser output. A plurality of voltage levels are tested at one time instead of relying on successive approximation, reducing the number of laser emissions and waiting determinations, thereby significantly improving the efficiency of output voltage determination. The reflected signals are precisely measured and processed, such that the required output voltage can be determined more accurately, thereby improving the quality and efficiency of laser processing. Quickly and accurately determining the output voltage ensures that the laser device outputs stable and appropriate laser energy during laser processing and ranging. In this way, in laser processing, processing quality and efficiency are improved, and in laser ranging, target objects at different distances can be measured more accurately, avoiding the problem of excessively strong laser energy during close-range measurement.

In an optional embodiment, the step of processing the plurality of reflected laser pulse signals to obtain a target pulse signal includes: superimposing the plurality of reflected laser pulse signals to obtain the target pulse signal.

In the above embodiment, the plurality of reflected laser pulse signals are superimposed to obtain the target pulse signal. This superimposition processing can enhance the intensity of the target pulse signal while suppressing the influence of noise and interference signals to a certain extent. Specifically, since the target pulse signal is reflected from the same target, it has similar waveforms and features in the plurality of pulse signals. These similar signal components can be enhanced through superimposition processing. In contrast, noise and interference signals are random and uncorrelated, so their intensity is offset or weakened to a certain extent during the superimposition process. In other words, the intensity of the target pulse signal is enhanced, and noise and interference are suppressed.

In practical applications, laser pulses emitted by lidar or similar devices are reflected back after encountering a target, forming reflected laser pulse signals. However, due to factors such as environmental noise, a plurality of reflections, and equipment errors, the received reflected laser pulse signals often contain a plurality of signal components. Alternatively, when a plurality of laser pulses with different output voltages are emitted, a single reflected signal may not be strong enough or clear enough due to environmental noise or other factors, making it difficult to directly extract useful information. Through superimposition processing, the signal-to-noise ratio of the effective signal can be enhanced, making it easier to identify and analyze. The target pulse signal after superimposition processing can more accurately reflect the distance information of the target object, thereby making the corresponding output voltage more precise and improving the quality and efficiency of laser processing or laser ranging.

In an optional embodiment, the step of determining, based on the target pulse signal, a target distance value corresponding to a target pulse peak value includes: determining the target pulse peak value from the target pulse signal, where the target pulse peak value is used to represent a maximum signal amplitude value in the target pulse signal; determining a target flight time corresponding to the target pulse peak value; and obtaining the target distance value based on the target flight time.

In the above embodiment, the largest signal amplitude value, namely the target pulse peak value, is identified from the target pulse signal. This step ensures that the strongest and most reliable portion of the reflected laser pulse signals is selected. Next, the flight time corresponding to the target pulse peak value is determined, that is, the time experienced by the pulse from emission to reflection by the target object and reception. Finally, the target distance value is calculated based on the flight time and the known pulse propagation speed (such as the speed of light), using the formula distance = speed × time. In lidar, sonar, or other pulse signal-based ranging technologies, the target pulse peak value usually represents the portion with the greatest intensity in the received reflected signal from the target. It is directly associated with the flight time of the pulse from emission to reception, and thus the distance between the target and the emission source can be calculated. The pulse peak value with the largest signal amplitude value is accurately identified, such that the flight time of the laser signal round trip between the target object and the laser device can be determined more reliably. There is a direct proportional relationship between the flight time and the distance (considering the speed of light as a constant). Therefore, once the target flight time is determined, the target distance value can be accurately calculated. In other words, as the target pulse peak value is identified to calculate the distance, the influence of noise and interference can be reduced to the greatest extent, improving the accuracy of the measurement result. The target pulse peak value is usually the most obvious feature in the reflected signal, so this method has high reliability in various environments. This method is not only applicable to lidar but also can be applied to other pulse signal-based ranging technologies, such as sonar and ultrasonic ranging. In this embodiment, the target pulse peak value can be quickly and accurately determined from the target pulse signal, and the corresponding target flight time can be further obtained, thereby calculating the target distance value and improving the speed and accuracy of output voltage determination.

In an optional embodiment, the step of determining, based on a predetermined correspondence, a target output voltage corresponding to the target distance value includes: establishing the predetermined correspondence, where the predetermined correspondence is used to represent a correspondence between a measurement distance and an output voltage; and determining, as the target output voltage, an output voltage corresponding to the target distance value in the predetermined correspondence.

In the above embodiment, the target output voltage corresponding to the target distance value can be quickly determined by establishing the predetermined correspondence. This avoids the time consumption problem of a plurality of laser emissions and waiting in the conventional feedback adjustment method, reduces the number of laser emissions and waiting determinations, and significantly improves the efficiency of output voltage determination. As the predetermined correspondence is established, the output voltage value corresponding to the target distance value can be accurately found. This correspondence can be obtained based on historical experimental data, theoretical calculations, or device characteristics, thereby improving the efficiency of output voltage determination. The predetermined correspondence can be adjusted based on the requirements of specific application scenarios. For example, different correspondences can be set in different measurement ranges to adapt to different precision requirements. In addition, with the changes of device characteristics (such as aging or temperature changes), the predetermined correspondence can be updated to maintain the accuracy of the conversion. Through the pre-established correspondence table between the measurement distance and the output voltage, the corresponding optimal output voltage can be immediately searched after the target distance value is determined. This method not only greatly simplifies the operation process and improves efficiency but also ensures that the most suitable output voltage is used for each measurement, thereby improving the stability of the laser device operation and the accuracy of the measurement results.

In an optional embodiment, the step of establishing the predetermined correspondence includes: acquiring a plurality of sets of historical measurement data, where each set of historical measurement data includes data of a different measurement distance and data of a corresponding output voltage; and constructing an objective function based on the plurality of sets of historical measurement data, where the objective function represents a function between the output voltage and the measurement distance.

In the above embodiment, a plurality of sets of historical measurement data are acquired, and the objective function is constructed based on these data, making the relationship between the output voltage and the measurement distance clearer and more accurate. This enables quick and accurate establishment of the predetermined correspondence, thereby improving the accuracy and speed of output voltage determination. In practical applications, due to various reasons such as device characteristics and environmental factors, the relationship between the output voltage and the measurement distance may also be nonlinear. As the plurality of sets of historical measurement data are acquired and the objective function is constructed based on these data, the nonlinear relationship between the output voltage and the measurement distance can be described more accurately. This method better reflects the actual situation than simple linear fitting or empirical formulas, thereby improving the accuracy of the conversion. Since the objective function is constructed based on historical measurement data, it can automatically adapt to changes in conditions such as device characteristics and environmental factors. In this embodiment, a large amount of historical measurement data is acquired and the objective function is constructed based on these data, achieving a more precise correspondence between the output voltage and the measurement distance. This method utilizes the data accumulation in actual operations and, through data analysis and modeling, can more scientifically reflect the optimal working state of the device at different distances. The predetermined correspondence established thereby can not only improve the working efficiency and accuracy of the laser device but also reduce errors caused by human factors. Certainly, on some occasions where the measurement accuracy requirements are not high, linear fitting can also be performed based on historical measurement data to obtain a simple linear function relationship between the output voltage and the measurement distance.

In an optional embodiment, the step of determining, based on the predetermined correspondence, the target output voltage corresponding to the target distance value includes: determining a target distance interval to which the target distance value belongs; and determining, based on the predetermined correspondence, the target output voltage corresponding to the target distance interval, where the predetermined correspondence includes a plurality of sets of correspondences between measurement distance intervals and output voltages.

In the above embodiment, the target distance interval to which the target distance value belongs is first determined, and then the output voltage corresponding to the target distance interval is determined based on the predetermined correspondence. The entire measurement distance range is divided into a plurality of intervals and the corresponding output voltage value is pre-determined for each interval, greatly reducing the search time. When it is necessary to determine the target output voltage, it is only necessary to find the interval to which the target distance value belongs and then directly read the output voltage value of that interval, without traversing the entire predetermined correspondence table. Since the measurement distance in practical applications may be a continuous value and the output voltage of the laser device is usually adjusted in certain steps, a mechanism is needed to convert the continuous distance value into a discrete output voltage adjustment scheme. If the interval division method is not adopted, a large amount of experimental data may be required to establish a detailed voltage-distance relationship, which is neither economical nor practical in actual operations. The target distance value is allocated to the preset distance interval and the output voltage is determined based on the interval, such that the process of determining the output voltage can be simplified. This method can not only reduce the complexity of data processing but also improve the speed and accuracy of output voltage adjustment. Additionally, through interval division, the performance requirements of the laser device can be better met in different distance measurement ranges, ensuring optimal voltage configuration in each interval.

For example, the output voltage corresponding to the measurement distance within [150 m, 200 m] is 10 V, the corresponding output voltage for the measurement distance within [120 m, 150 m) is 8.5 V, and the corresponding output voltage for the measurement distance within [100 m, 120 m) is 7 V. It should be noted that this is only an example. In practical applications, the output voltages of different laser devices may be different, and various measurement distance intervals may correspond to other different output voltages. In practical applications, the number and range of intervals can be adjusted based on actual application requirements. For example, when the measurement distance variation range is large or the relationship between the output voltage and the measurement distance is complex, the number of intervals can be increased to improve search accuracy. When the measurement distance variation range is small or the relationship between the output voltage and the measurement distance is simple, the number of intervals can be reduced to improve search efficiency.

In an optional embodiment, the step of processing the plurality of reflected laser pulse signals to obtain a target pulse signal includes: generating a target histogram based on the plurality of reflected laser pulse signals, where the target histogram is used to represent photon counts corresponding to different flight times, and the target pulse signal is represented by using the target histogram; and the determining, based on the target pulse signal, a target distance value corresponding to a target pulse peak value includes: determining, based on the target histogram, a target flight time corresponding to a maximum photon count, and determining the target distance value based on the target flight time.

In the above embodiment, the target histogram is generated from the plurality of reflected laser pulse signals, and the target histogram is used to represent photon counts corresponding to different flight times. This enables more precise determination of the target pulse peak value, thereby improving the accuracy of the target flight time and the target distance value, and ultimately making the determination of the target output voltage more precise. The target histogram provides an intuitive visual presentation, making peak detection more accurate. Even in cases where the signal is weak or the noise is large, the target pulse peak value can be accurately determined by comparing the photon counts at different flight times. Since the target histogram can accurately reflect the flight time corresponding to the maximum photon count, the target distance value can be calculated more precisely based on this flight time. In practical applications, the receiver may receive reflected laser pulse signals from a plurality of targets at different distances, as well as interference signals such as background noise. These signals are mixed together, making it difficult to directly determine the target distance. As the target histogram is generated, signals at different flight times can be distinguished, facilitating subsequent processing. Conventional methods may have difficulty accurately detecting the peak value of the reflected laser pulse signal, especially in cases where the signal is weak or the noise is large. The target histogram is used to represent the photon counts (or the intensity of the reflected laser pulse signals) corresponding to different flight times. Through the target histogram, the distribution of photon counts can be clearly seen, thereby determining the target pulse peak value more accurately.

In an optional embodiment, the plurality of transmitted laser pulse signals include a first transmitted laser pulse signal, a second transmitted laser pulse signal, and a third transmitted laser pulse signal. The first transmitted laser pulse signal, the second transmitted laser pulse signal, and the third transmitted laser pulse signal are generated based on a first voltage, a second voltage, and a third voltage, respectively. The plurality of reflected laser pulse signals include a first reflected laser pulse signal, a second reflected laser pulse signal, and a third reflected laser pulse signal. Processing the plurality of reflected laser pulse signals to obtain the target pulse signal includes superimposing the first reflected laser pulse signal, the second reflected laser pulse signal, and the third reflected laser pulse signal to obtain the target pulse signal.

In the above embodiment, the first voltage may be the lower limit voltage of the output voltage range of the laser device, the second voltage may be the intermediate value of the output voltage range, and the third voltage may be the upper limit voltage of the output voltage range. For example, assuming the output voltage range of the laser device is 1 V–10 V, the first voltage is 1 V, the second voltage is 5 V (or 7 V, or 8 V, or others), and the third voltage is 10 V. Certainly, the first voltage, the second voltage, and the third voltage can all be intermediate values within the output voltage range, for example, 2 V, 5 V, and 9 V, respectively, or others.

It should be noted that the embodiments described above are only a part of the embodiments of this application, not all of the embodiments. The following specifically describes this application in combination with specific embodiments.

An embodiment of this application provides a laser output voltage determination method, which can be used to quickly determine the output voltage. The method includes the following steps:

emitting laser: applying a plurality of voltages to a laser emitting end, and emitting lasers with different powers;

processing received laser signals: receiving a plurality of laser signal waveforms reflected back, and superimposing values corresponding to the plurality of laser signal waveforms, to obtain the highest point of the laser signal waveform;

determining a target output voltage: determining distance information at the highest point of the waveform, where the distance information is a distance obtained by laser measurement, and determining the target output voltage based on a predetermined correspondence between a measurement distance and an output voltage.

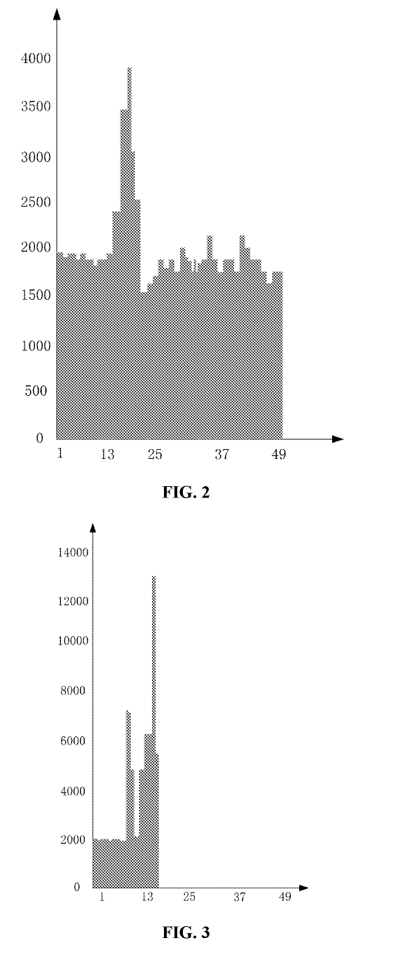

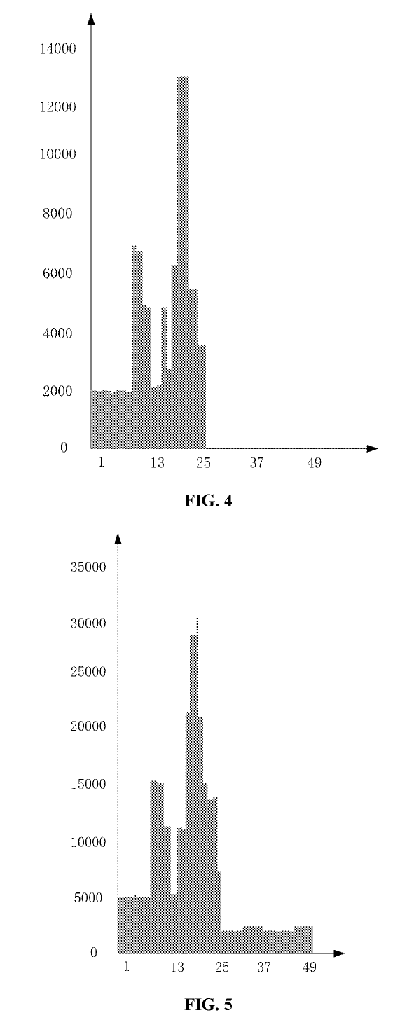

FIG. 2, FIG. 3, and FIG. 4 are schematic diagrams of received signals corresponding to the lower limit voltage, the preset voltage, and the upper limit voltage, respectively. For example, assuming the output voltage range of the laser device is 1 V–10 V, the lower limit voltage is 1 V, the upper limit voltage is 10 V, and the preset voltage is an intermediate value within the output voltage range, such as 5 V (or 7 V, or other voltages). In FIG. 2 to FIG. 4, the horizontal coordinate is used to represent the flight time, and the vertical coordinate represents the signal intensity. FIG. 5 is obtained by superimposing the received signals of FIG. 2 to FIG. 4. The flight time corresponding to the highest point (or peak value) after superimposition is determined as the target flight time. The distance of the measured object can be calculated based on the target flight time. Then, the target output voltage is determined based on the predetermined correspondence between the distance and the output voltage.

It should be noted that the above is only described by taking three voltages (such as the lower limit voltage, the preset voltage, and the upper limit voltage) as examples. In practical applications, lasers corresponding to more different voltages can also be emitted, and then the received laser signals are processed in the same method as above to determine the distance information corresponding to the highest point (that is, the peak value), and then determine the target output voltage.

In the embodiment of this application, the effect of improving the efficiency of determining the laser output voltage is achieved.

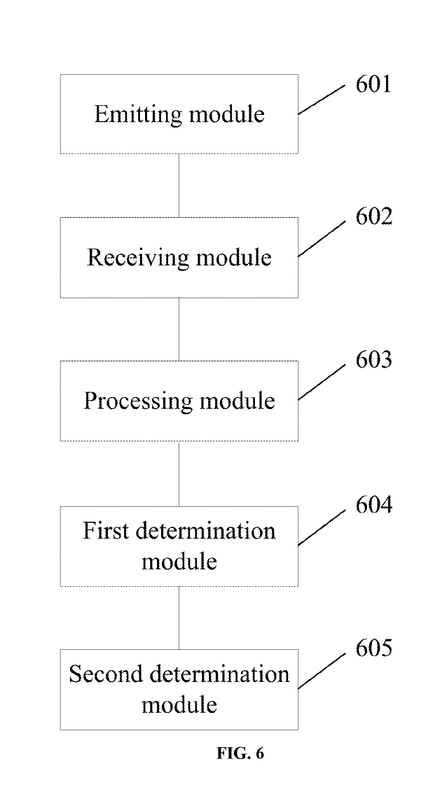

This application also provides an apparatus for determining an output voltage, located in a laser device. As shown in FIG. 6, FIG. 6 is a structural block diagram of an apparatus for determining an output voltage according to an embodiment of this application. The apparatus includes:

an emitting module 601, configured to emit a plurality of transmitted laser pulse signals toward a target object, where each transmitted laser pulse signal in the plurality of transmitted laser pulse signals is generated based on a different output voltage;

a receiving module 602, configured to receive a plurality of reflected laser pulse signals reflected back from the target object, where each reflected laser pulse signal in the plurality of reflected laser pulse signals corresponds to one transmitted laser pulse signal in the plurality of transmitted laser pulse signals;

a processing module 603, configured to process the plurality of reflected laser pulse signals to obtain a target pulse signal;

a first determination module 604, configured to determine, based on the target pulse signal, a target distance value corresponding to a target pulse peak value; and

a second determination module 605, configured to determine, based on a predetermined correspondence, a target output voltage corresponding to the target distance value.

Through the above apparatus, the target output voltage applicable to the laser device can be determined quickly and accurately. Specifically, the emitting module emits a plurality of transmitted laser pulse signals generated based on different output voltages toward the target object, and the receiving module receives the corresponding reflected laser pulse signals. The target pulse signal is obtained by processing these reflected laser pulse signals, and then the target distance value is determined based on the pulse peak value in the target pulse signal. Finally, the target output voltage suitable for the target distance value is determined based on the predetermined correspondence. The apparatus of this application avoids the time consumption problem of a plurality of laser emissions and waiting for determination of the target voltage in the conventional feedback adjustment method, significantly improving the efficiency of output voltage determination.

In an optional embodiment, the processing module 603 includes a superimposition unit, configured to superimpose the plurality of reflected laser pulse signals to obtain the target pulse signal.

In an optional embodiment, the first determination module 604 includes a first determination unit, configured to determine the target pulse peak value from the target pulse signal, where the target pulse peak value is used to represent the maximum signal amplitude value in the target pulse signal; a second determination unit, configured to determine a target flight time corresponding to the target pulse peak value; and an obtaining unit, configured to obtain the target distance value based on the target flight time.

In an optional embodiment, the second determination module 605 includes an establishing unit, configured to establish the predetermined correspondence, where the predetermined correspondence is used to represent a correspondence between a measurement distance and an output voltage; and a third determination unit, configured to determine, as the target output voltage, an output voltage corresponding to the target distance value in the predetermined correspondence.

In an optional embodiment, the establishing unit includes an acquiring subunit, configured to acquire a plurality of sets of historical measurement data, where each set of historical measurement data includes data of a different measurement distance and data of a corresponding output voltage; and a constructing subunit, configured to construct an objective function based on the plurality of sets of historical measurement data, where the objective function represents a function between the output voltage and the measurement distance.

In an optional embodiment, the second determination module 605 includes a fourth determination unit, configured to determine a target distance interval to which the target distance value belongs; and a fifth determination unit, configured to determine, based on the predetermined correspondence, the target output voltage corresponding to the target distance interval, where the predetermined correspondence includes a plurality of sets of correspondences between measurement distance intervals and output voltages.

In an optional embodiment, the processing module 603 includes a generating unit, configured to generate a target histogram based on the plurality of reflected laser pulse signals, where the target histogram is used to represent photon counts corresponding to different flight times, and the target pulse signal is represented by using the target histogram. The first determination module 604 includes a sixth determination unit, configured to determine, based on the target histogram, a target flight time corresponding to a maximum photon count; and a seventh determination unit, configured to determine the target distance value based on the target flight time.

This application also provides a computer-readable storage medium, where the computer-readable storage medium stores instructions, and the instructions, when executed, implement any of the above method steps.

In an exemplary embodiment, the computer-readable storage medium may include, but is not limited to, various media that can store computer programs, such as a USB flash drive, a read-only memory (ROM), a random access memory (RAM), a mobile hard disk, a magnetic disk, or an optical disk.

This application further discloses an electronic device. As shown in FIG. 7, FIG. 7 is a schematic structural diagram of an electronic device according to an embodiment of this application. The electronic device 700 may include: at least one processor 701, at least one network interface 704, a user interface 703, a memory 705, and at least one communication bus 702.

The communication bus 702 is configured to realize connection communication between these components.

The user interface 703 may include a display and a camera. Optionally, the user interface 703 may also include a standard wired interface and a wireless interface.

The network interface 704 may optionally include a standard wired interface and a wireless interface (such as a WI-FI interface).

The processor 701 may include one or more processing cores. The processor 701 connects various parts within the entire electronic device (such as a server) using various interfaces and lines, and executes various functions of the server and processes data by running or executing instructions, programs, code sets, or instruction sets stored in the memory 705, and by calling data stored in the memory 705. Optionally, the processor 701 may be implemented in at least one hardware form of digital signal processing (DSP), field-programmable gate array (FPGA), and programmable logic array (PLA). The processor 701 may integrate one or a combination of a central processing unit (CPU), a graphics processing unit (GPU), a modem, and the like. The CPU mainly processes the operating system, user interface, application programs, and the like. The GPU is responsible for rendering and drawing the content that needs to be displayed on the display screen. The modem is configured to process wireless communication. It can be understood that the modem may not be integrated into the processor 701 and may be implemented separately through a chip.

The memory 705 may include a random access memory (RAM) and may also include a read-only memory. Optionally, the memory 705 includes a non-transitory computer-readable storage medium. The memory 705 may be configured to store instructions, programs, codes, code sets, or instruction sets. The memory 705 may include a program storage area and a data storage area. The program storage area may store instructions for implementing the operating system, instructions for at least one function (such as touch function, sound playback function, or image playback function), instructions for implementing the above method embodiments, or the like. The data storage area may store data involved in the above method embodiments and the like. Optionally, the memory 705 may also be at least one storage device located away from the processor 701. Referring to FIG. 7, the memory 705 as a computer storage medium may include an operating system, a network communication module, a user interface module, and an application program of the method for determining an output voltage.

In the electronic device 700 shown in FIG. 7, the user interface 703 is mainly configured to provide an input interface for the user and acquire data input by the user. The processor 701 may be configured to call the application program of the method for determining an output voltage stored in the memory 705. When executed by one or more processors 701, the electronic device 700 performs the method as described in one or more of the above embodiments.

In the above examples, the description of the examples each has a focus, and portions not described in detail in one example may refer to the description of other examples.

In several examples provided herein, it should be understood that the disclosed apparatus may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In other respects, the intercoupling or direct coupling or communication connection shown or discussed may be indirect coupling or communication connection through some service interfaces, apparatuses, or units, or may be implemented in an electrical or other forms.

The units described as separate parts may or may not be physically separate. Parts shown as units may or may not be physical units, which may be located in one position, or may be distributed on a plurality of network units. Some or all of the units may be selected according to actual needs to achieve the objectives of the solutions of embodiments.

In addition, functional units in the embodiments of this application may be integrated into one processing unit, or each of the units may exist alone physically, or two or more units are integrated into one unit. The above integrated unit may be implemented either in a form of hardware or in a form of a software functional unit.

The integrated unit, if implemented in the form of a software functional unit and sold or used as a stand-alone product, may be stored in a computer-readable memory. Based on such an understanding, the technical solutions in this application essentially, or the part contributing to the prior art, or all or some of the technical solutions may be implemented in a form of a software product. The computer software product is stored in a memory, and includes instructions for instructing a computer device (which may be a personal computer, a server, a network device, or the like) to perform all or some of the operations of the methods described in the embodiments of this application. The aforementioned memory devices include USB drives, external hard drives, disks, or optical discs, and other media capable of storing program code.

The foregoing descriptions are merely exemplary embodiments of the present disclosure, which cannot be construed as a limitation on the scope of the present disclosure. Any equivalent changes and modifications made in accordance with the teachings of the present disclosure still fall within the scope of the present disclosure. A person skilled in the art can easily think of other implementation solutions of the present disclosure after considering the specification and practicing the content disclosed herein.

The present disclosure is intended to cover any variations, purposes, or adaptive changes of the present disclosure. Such variations, purposes, or applicable changes follow the general principle of the present disclosure and include common knowledge or conventional technical means in the technical field which is not disclosed in the present disclosure.

What is claimed is:

1. A method for determining an output voltage, applied to a laser device and comprising:
emitting a plurality of transmitted laser pulse signals toward a target object, wherein each transmitted laser pulse signal in the plurality of transmitted laser pulse signals is generated based on a different output voltage;
receiving a plurality of reflected laser pulse signals reflected back from the target object, wherein each reflected laser pulse signal in the plurality of reflected laser pulse signals corresponds to one transmitted laser pulse signal in the plurality of transmitted laser pulse signals;
processing the plurality of reflected laser pulse signals to obtain a target pulse signal;
determining, based on the target pulse signal, a target distance value corresponding to a target pulse peak value; and
determining, based on a predetermined correspondence, a target output voltage corresponding to the target distance value.

2. The method according to claim 1, wherein the processing the plurality of reflected laser pulse signals to obtain a target pulse signal comprises:
superimposing the plurality of reflected laser pulse signals to obtain the target pulse signal.

3. The method according to claim 1, wherein the determining, based on the target pulse signal, a target distance value corresponding to a target pulse peak value comprises:
determining the target pulse peak value from the target pulse signal, wherein the target pulse peak value is used to represent a maximum signal amplitude value in the target pulse signal;
determining a target flight time corresponding to the target pulse peak value; and
obtaining the target distance value based on the target flight time.

4. The method according to claim 1, wherein the determining, based on a predetermined correspondence, a target output voltage corresponding to the target distance value comprises:
establishing the predetermined correspondence, wherein the predetermined correspondence is used to represent a correspondence between a measurement distance and an output voltage; and
determining, as the target output voltage, an output voltage corresponding to the target distance value in the predetermined correspondence.

5. The method according to claim 4, wherein the establishing the predetermined correspondence comprises:
acquiring a plurality of sets of historical measurement data, wherein each set of historical measurement data comprises data of a different measurement distance and data of a corresponding output voltage; and
constructing an objective function based on the plurality of sets of historical measurement data, wherein the objective function represents a function between the output voltage and the measurement distance.

6. The method according to claim 1, wherein the determining, based on a predetermined correspondence, a target output voltage corresponding to the target distance value comprises:
determining a target distance interval to which the target distance value belongs, and
determining, based on the predetermined correspondence, the target output voltage corresponding to the target distance interval, wherein the predetermined correspondence comprises a plurality of sets of correspondences between measurement distance intervals and output voltages.

7. The method according to claim 1, wherein
the processing the plurality of reflected laser pulse signals to obtain a target pulse signal comprises: generating a target histogram based on the plurality of reflected laser pulse signals, wherein the target histogram is used to represent photon counts corresponding to different flight times, and the target pulse signal is represented by using the target histogram; and
the determining, based on the target pulse signal, a target distance value corresponding to a target pulse peak value comprises: determining, based on the target histogram, a target flight time corresponding to a maximum photon count, and determining the target distance value based on the target flight time.

8. An apparatus for determining an output voltage, located in a laser device, and comprising:
an emitting module, configured to emit a plurality of transmitted laser pulse signals toward a target object, wherein each transmitted laser pulse signal in the plurality of transmitted laser pulse signals is generated based on a different output voltage;
a receiving module, configured to receive a plurality of reflected laser pulse signals reflected back from the target object, wherein each reflected laser pulse signal in the plurality of reflected laser pulse signals corresponds to one transmitted laser pulse signal in the plurality of transmitted laser pulse signals;
a processing module, configured to process the plurality of reflected laser pulse signals to obtain a target pulse signal;
a first determination module, configured to determine, based on the target pulse signal, a target distance value corresponding to a target pulse peak value; and
a second determination module, configured to determine, based on a predetermined correspondence, a target output voltage corresponding to the target distance value.

9. An electronic device, comprising a memory and a processor, wherein a computer program is stored on the memory, and the processor, when executing the program, implements the method according to claim 1.

10. A computer-readable storage medium, wherein the computer-readable storage medium stores instructions, and the instructions, when executed, implement the method according to claim 1.
